(19) United States
(12) Patent Application Publication
(10) Pub. No.: US 2005/0174028 A1
(43) Pub. Date: Aug. 11, 2005

(54) Field emission device and backlight device using the field emission device and method of manufacture thereof

(76) Inventors: Jae-Eun Jung, Seoul (KR); Jong-Min Kim, Suwon-si (KR); Tae-Sik Oh, Suwon-si (KR); Young-Jun Park, Suwon-si (KR)

Correspondence Address: Robert E. Bushnell, Suite 300, 1522 K Street, N.W., Washington, DC, 20005-1202, US

(21) Appl. No.: 11/048,810

(22) Filed: Feb. 3, 2005

(30) Foreign Application Priority Data
Feb. 9, 2004 (KR) 10-2004-0008341

(51) Int. Cl. H01J 1/02; H01J 1/14

(52) U.S. Cl. 313/309; 313/311; 313/351

(57) ABSTRACT

A field emission device and a backlight device using the field emission device includes a cathode electrode and a gate electrode formed in alternating parallel strips on a substrate, a catalytic metal layer arranged on the cathode electrode and adapted to enhance Carbon NanoTube (CNT) growth, and grown CNTs arranged on the catalytic metal layer.

### CLAIM OF PRIORITY

This application makes reference to, incorporates the same herein, and claims all benefits accruing under 35 U.S.C. §119 from an application for FIELD EMISSION DEVICE AND BACKLIGHT DEVICE USING THE SAME earlier filed in the Korean Intellectual Property Office on 9 Feb. 2004 and there duly assigned Serial No. 10-2004-0008341.

### BACKGROUND OF THE INVENTION

1. Field of the Invention

The present invention relates to a field emission device and a backlight device using the field emission device and a method of manufacture thereof, and more particularly, to a field emission device employing Carbon NanoTubes (CNTs) and a backlight device using the field emission device and a method of manufacture thereof.

2. Description of the Related Art

In general, flat panel displays are roughly classified into light emitting displays and light receiving displays. The light emitting type displays include Cathode Ray Tubes (CRTs), plasma display panels (PDPs), Field Emission Displays (FEDs), and the like. The light receiving displays include Liquid Crystal Displays (LCDs). The LCDs are light in weight and consume little electric power. However, LDCs themselves cannot emit light to form images. They can form images by using light entering from the outside. Thus, it is impossible to observe the images in a dark place. To overcome this problem, backlight devices are installed in the back of the LCDs.

In the Past, Cold Cathode Fluorescent Lamps (CCFLs), which are line light sources, and Light Emitting Diodes (LEDs), which are point light sources, were mainly used as backlight devices. However, in general, such backlight devices have a complicated construction, thereby being quite expensive. Furthermore, light sources are disposed in the lateral sides of the backlight devices and thus, due to the reflection and transmission of light, consumption of electrical power increases. Especially, as LCDs become larger, it becomes more difficult to ensure uniform brightness of a backlight device.

Accordingly, to overcome the above problems, field emission backlights having a light emitting structure in a plate configuration have been suggested. The field emission type backlight devices consume less electrical power than backlight devices such as cold cathode fluorescent lamps. Furthermore, they advantageously have relatively uniform brightness even with a large light emitting area.

In a field emission backlight device, a top substrate and a bottom substrate are disposed opposite to each other and spaced apart from each other by a predetermined distance. An anode electrode and a fluorescent layer are sequentially formed on an inner surface of the top substrate. A cathode electrode is formed on an upper surface of the bottom substrate. A gate insulating layer having a through hole is formed on the cathode electrode. A gate electrode is formed on the gate insulating layer, and the gate electrode has a gate hole, which corresponds to the through hole. CNT emitters are formed on an exposed surface of the cathode electrode through the through hole.

For the field emission type backlight device having the above structure, when a voltage Vₐ of several kilovolts is supplied to the anode electrode and a voltage V_{g} of several tens of volts is supplied to the gate electrode, electrons are emitted from the CNT emitters toward the anode electrode. The electrons excite the fluorescent layer to emit visible light.

The CNT emitters can be produced by screen printing a paste containing CNTs on the exposed surface of the cathode electrode through the gate hole, followed by etching.

However, the density of the CNT emitters produced by the screen printing method is low, thereby causing a problem in obtaining a field emission device having a high brightness.

Moreover, the field emission device having the layered structure noted above needs repetitive patterning, which results in high production costs.

### SUMMARY OF THE INVENTION

The present invention provides a field emission device having a high density of CNT emitters and a backlight device using the field emission device.

The present invention also provides a field emission device manufactured by a simple process in which a cathode electrode and a gate electrode are disposed on the same plane, and a backlight device using the field emission device.

According to an aspect of the present invention, a field emission device is provided comprising: a cathode electrode and a gate electrode formed in alternating parallel strips on a substrate; a catalytic metal layer formed on the cathode electrode and adapted to enhance carbon nanotube (CNT) growth ; and grown CNTs arranged on the catalytic metal layer.

The catalytic metal layer adapted to enhance carbon nanotube (CNT) growth can be discontinuously formed on the cathode electrode.

Alternatively, the catalytic metal layer adapted to enhance carbon nanotube (CNT) growth can be continuously formed on the cathode electrode.

The catalytic metal layer adapted to enhance carbon nanotube (CNT) growth can be composed of at least one metal selected from the group consisting of Ni, Co, Fe and inbar.

According to another aspect of the present invention, a field emission backlight device is provided comprising: a top substrate and a bottom substrate disposed in parallel and spaced apart from each other by a predetermined distance; an anode electrode formed on the top substrate; a fluorescent layer formed on the anode electrode and having a predetermined thickness; a cathode electrode and a gate electrode formed in alternating parallel strips on the bottom substrate; a catalytic metal layer formed on the cathode electrode and adapted to enhance CNT growth; and grown CNTs arranged on the catalytic metal layer.

According to yet another aspect of the present invention, a method of manufacturing a field emission device is provided, the method comprising: arranging a cathode electrode and a gate electrode in alternating parallel strips on a substrate; arranging a catalytic metal layer on the cathode electrode to enhance Carbon NanoTube (CNT) growth ; and growing CNTs on the catalytic metal layer.

The catalytic metal layer can be discontinuously arranged on the cathode electrode.

Alternatively, the catalytic metal layer can be continuously arranged on the cathode electrode.

The catalytic metal layer can be composed of at least one metal selected from the group consisting of Ni, Co, Fe, and inbar.

According to still another aspect of the present invention, a method of manufacturing a field emission type backlight device is provided, the method comprising: arranging a top substrate and a bottom substrate in parallel and spaced apart from each other by a predetermined distance; arranging an anode electrode on the top substrate; arranging a fluorescent layer on the anode electrode, the fluorescent layer having a predetermined thickness; arranging a cathode electrode and a gate electrode in alternating parallel strips on the bottom substrate; arranging a catalytic metal layer on the cathode electrode to enhance CNT growth; and growing CNTs on the catalytic metal layer.

The catalytic metal layer can be discontinuously arranged on the cathode electrode.

Alternatively, the catalytic metal layer can be continuously arranged on the cathode electrode.

The catalytic metal layer can be composed of at least one metal selected from the group consisting of Ni, Co, Fe, and inbar.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial cross-sectional view of a field emission type backlight device;

FIG. 2 is a schematic cross-sectional view of a backlight device according to an embodiment of the present invention;

FIG. 3 is a schematic top view of a field emission device of FIG. 2 according to another embodiment of the present invention; and

FIG. 4 is a schematic top view of a modification of a field emission device according to an embodiment of the present invention.

### DETAILED DESCRIPTION OF THE INVENTION

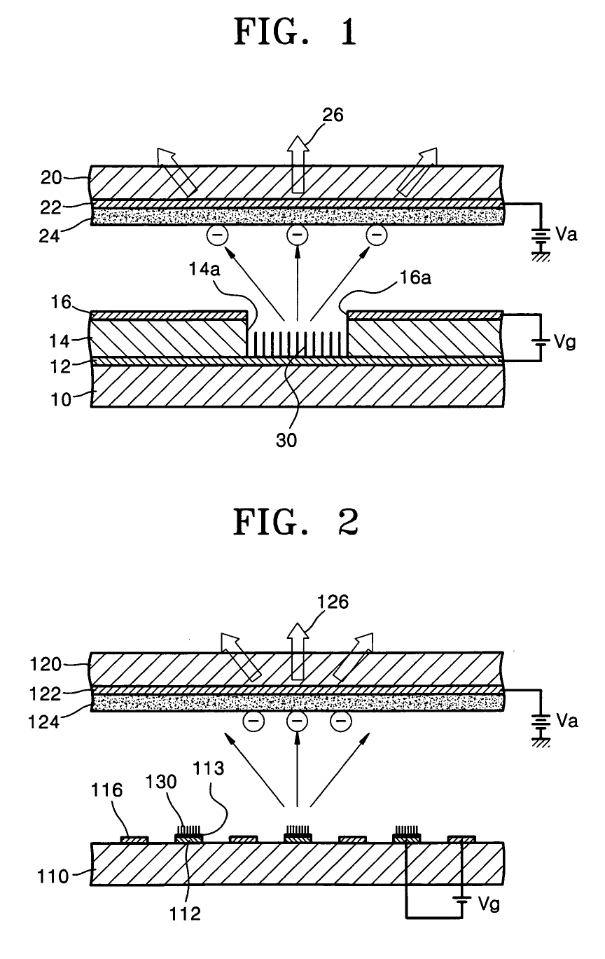

FIG. 1 is a partial cross-sectional view of a field emission type backlight device.

Referring to FIG. 1, a top substrate 20 and a bottom substrate 10 are disposed opposite to each other and spaced apart from each other by a predetermined distance. An anode electrode 22 and a fluorescent layer 24 are sequentially formed on an inner surface of the top substrate 20. A cathode electrode 12 is formed on an upper surface of the bottom substrate 10. A gate insulating layer 14 having a through hole 14a is formed on the cathode electrode 12. A gate electrode 16 is formed on the gate insulating layer 14, and the gate electrode 16 has a gate hole 16a corresponding to the through hole 14a. CNT emitters 30 are formed on an exposed surface of the cathode electrode 12 through the through hole 14a.

For the field emission type backlight device having the above structure, when a voltage Vₐ of several kilovolts is supplied to the anode electrode 22 and a voltage V_{g} of several tens of volts is supplied to the gate electrode 16, electrons are emitted from the CNT emitters 30 toward the anode electrode 22. The electrons excite the fluorescent layer 24 to emit visible light 26.

The CNT emitters 30 can be produced by screen printing a paste containing CNTs on the exposed surface of the cathode electrode 12 through the gate hole 16a, followed by etching.

However, the density of the CNT emitters 30 produced by the screen printing method is low, thereby causing a problem in obtaining a field emission device having a high brightness.

Moreover, a field emission device having the layered structure noted above needs repetitive patterning, resulting in high production costs.

Hereinafter, a field emission device and a backlight device according to exemplary embodiments of the present invention will be described in detail with reference to the attached drawings. In the drawings, the size of layers and zones has been exaggerated for clarity.

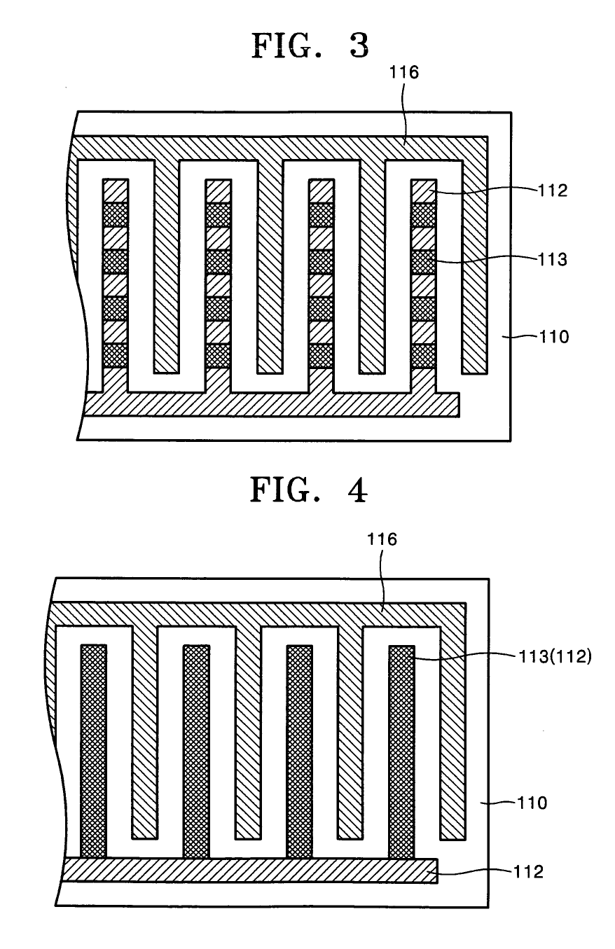

FIG. 2 is a schematic cross-sectional view of a backlight device according to an embodiment of the present invention. FIG. 3 is a schematic top view of the field emission device of FIG. 2 according to an embodiment of the present invention.

Referring to FIGS. 2 and 3, a top substrate 120 and a bottom substrate 110 are disposed opposite to each other and spaced apart from each other by a predetermined distance. An anode electrode 122 and a fluorescent layer 124 are sequentially formed on an inner surface of the top substrate 120. A field emission device is formed on an upper surface of the bottom substrate 110.

In the field emission device, a cathode electrode 112 and a gate electrode 116 are formed in alternating parallel strips on the bottom substrate 110. The cathode electrode 112 and the gate electrode 116 can be obtained by depositing Cr or ITO on the bottom substrate 110, followed by patterning.

The gate electrode 116 extract electrons from CNT emitters 130 formed on the cathode electrode 112 therebetween. A voltage V_{g} of several tens of volts, for example, 40 V, is supplied to the gate electrode 116.

A thin metallic film 113 is formed on the cathode electrode 112. The thin metallic film 113 is a catalytic metal layer added to enhance CNT growth and is composed of at least one metal selected from the group consisting of Ni, Co, Fe and inbar. The thin metallic film 113 can have a thickness of about 1 μm.

The thin metallic film 113 can be discontinuously formed on the cathode electrode 112 of FIG. 3. However, the present invention is not limited thereto. That is, referring to FIG. 4, the thin metallic film 113 can be continuously formed on the cathode electrode 112. The discontinuous metallic film of a predetermined size can be formed by a surface mounting technique, such as chip mounting. The continuous metallic film 113 can be formed by heat transfer.

The CNT emitters 130 are formed on the thin metallic film 113. The CNT emitters 130 are obtained by disposing the bottom substrate 110 on which the thin metallic film 113 is formed in a chamber at a predetermined temperature, for example, 750° C., and injecting a carbon-containing gas into the chamber to grow carbon nanotubes from the surface of the thin metallic film 113. Methane (CH₄), acetylene (C₂H₂), ethylene (C₂H₄), ethane (C₂H₆), carbon oxide (CO), carbon dioxide (CO₂) and so on can be used as the carbon-containing gas.

The CNT emitters 130 can be formed with high density on the thin metallic film 113 depending on the adsorption time of carbon.

Referring to FIG. 2, a voltage V_{g} of 40 V is supplied to the gate electrode 116 and a voltage Vₐ of 2 kV is supplied to the anode electrode 122. Then, electrons are emitted from the CNT emitters 130 and proceed toward the anode electrode 122 and collide with a fluorescent layer 124. Visible light 126 is generated by the fluorescent layer 124. Then, the visible light 126 passes through the top substrate 120.

In the field emission device according to an embodiment of the present invention, the CNT emitters can be formed with an increased density on the cathode electrode, thereby enhancing an electron-emitting capacity of the CNT emitters. Thus, the backlight device using the field emission device exhibits a high brightness.

In addition, in the field emission device according to an embodiment of the present invention, the gate electrode can be manufactured by a simple process in which a cathode electrode and a gate electrode are disposed on the same plane. Thus, the field emission type backlight device can be manufactured at a low cost.

While the present invention has been particularly shown and described with reference to exemplary embodiments thereof, it will be understood by those of ordinary skill in the art that various changes in form and details can be made therein without departing from the spirit and scope of the present invention as defined by the following claims.

1. A field emission device comprising:
a cathode electrode and a gate electrode arranged in alternating parallel strips on a substrate;
a catalytic metal layer arranged on the cathode electrode and adapted to enhance Carbon NanoTube (CNT) growth; and
grown CNTs arranged on the catalytic metal layer.

2. The field emission device of claim 1, wherein the catalytic metal layer is discontinuously arranged on the cathode electrode.

3. The field emission device of claim 1, wherein the catalytic metal layer is continuously arranged on the cathode electrode.

4. The field emission device of claim 1, wherein the catalytic metal layer is composed of at least one metal selected from the group consisting of Ni, Co, Fe, and inbar.

5. A field emission type backlight device comprising:
a top substrate and a bottom substrate arranged in parallel and spaced apart from each other by a predetermined distance;
an anode electrode arranged on the top substrate;
a fluorescent layer arranged on the anode electrode and having a predetermined thickness;
a cathode electrode and a gate electrode arranged in alternating parallel strips on the bottom substrate;
a catalytic metal layer arranged on the cathode electrode and adapted to enhance Carbon NanoTube (CNT) growth; and
grown CNTs arranged on the catalytic metal layer.

6. The field emission type backlight device of claim 5, wherein the catalytic metal layer is discontinuously arranged on the cathode electrode.

7. The field emission type backlight device of claim 5, wherein the catalytic metal layer is continuously arranged on the cathode electrode.

8. The field emission type backlight device of claim 5, wherein the catalytic metal layer is composed of at least one metal selected from the group consisting of Ni, Co, Fe, and inbar.
